(19) United States
(12) Patent Application Publication
(10) Pub. No.: US 2004/0121825 A1
(43) Pub. Date: Jun. 24, 2004

(54) Rotary-wing type mobile telephone and a controlling method thereof

(76) Inventors: Yawei Ma, Chao Yang District (CN); Kejiao Luo, Chao Yang District (CN); Zhuoli Yu, Chao Yang District (CN)

Correspondence Address: A. Blair Hughes, McDonnell Boehnen Hulbert & Berghoff, 32nd Floor, 300 S. Wacker Drive, Chicago, IL, 60606, US

(21) Appl. No.: 10/642,405

(22) Filed: Aug. 15, 2003

(30) Foreign Application Priority Data
Dec. 24, 2002 (CN) 02157089.2

(51) Int. Cl. H04M 1/00; H04B 1/38

(52) U.S. Cl. 455/575.4; 455/566; 455/90.3

(57) ABSTRACT

The present invention discloses a rotary-wing type mobile telephone, the mobile telephone comprises a mobile telephone body and a rotary wing; the rotary wing is pivotally connecting to the mobile telephone body by a rotating shaft, wherein the rotating shaft comprises: a spindle provided at the center of the rotating shaft; a fixing member hitched on the spindle and fixedly connected with the rotary wing of mobile telephone; a rotating member pivotally provided on the spindle and fixedly connected with the mobile telephone body; a limit mechanism provided between the fixing member and the rotating member, the limit mechanism limits the rotary wing in the range of rotating through 180 degrees clockwise or counterclockwise.

### TECHNICAL FIELD

The present invention relates to a mobile telephone and a working method thereof, and more particularly, to a rotary-wing type mobile telephone and a working method thereof.

### BACKGROUND ART

With the development of science and technology and the improvement of living standard, mobile telephones have already been essential means of communication of people's daily life. After the basic-type and folding-type mobile telephone have been widely used in the market, the manufacturers beaten their brains out to develop new and fashionable products, in order to attract the consumer to stimulate consumer's purchasing appetence, thus getting a greater profit on them. A rotary-wing type mobile telephone emerges as the times require, as shown in FIGS. 1 and 2, a rotary wing 2′ is pivotally connected on a mobile telephone body 3′ by a rotating shaft 1′ and rotates about the rotating shaft 1′ freely, to provide a completely new operation mode for user.

However, the existing rotary-wing type mobile telephones still have many defects as follows:

1. The rotary wing can use only a contact-type elastic connector to transmit signals in order to rotate through 360° freely. This connection brings such defects that, it has poor reliability and can transmit only fewer simple signals, and it is not suitable for devices which are relatively complicated and have larger transmission quantity of signal, such as a LCD screen or the like, because a flexible printed board for connecting electrically between a LCD screen and a circuit card of mobile telephone may suffer from possible damages within its working life if it rotates through 360°, even though using wire jointing, it can also suffer from damages if it rotates through 360° in single direction.

2. The rotary wing 2′ rotates through 360° freely by rotating shaft 1′ having only rotating function. The rotary wing 2′ can be placed thereon only a few lighter members, and cannot be placed thereon relatively heavy members such as a LCD screen, because this easily leads to the deviation of center of gravity of the rotary wing, and the shaft itself has no such function as holding the angle of rotation, therefore, the rotary wing is unable to fasten stably in the receiving position, thus causing much inconvenience of usage. In this case, the LCD screen remains on the body, which makes little difference from basic-type.

3. The rotary wing 2′ is parallel to the mobile telephone body after it is opened. Thus, when the rotary wing closes to the ear, the mobile telephone body is separated from user by a greater distance, not being ergonomic.

As described above, there is a lot of inconvenience and defects in the existing rotary-wing type mobile telephone, which is expected to be further improved.

### DISCLOSURE OF THE INVENTION

Accordingly, it is main objects of the present invention to provide a rotary-wing type mobile telephone, which can realize multiple-signal transmission of the mobile telephone body and the rotary wing, at the same time, cannot lower the working life of the signal transmit media.

It is another object of the present invention to provide a rotary-wing type mobile telephone, which can lock the rotary wing at some position to be convenient for user to operate.

It is further object of the present invention to provide a rotary-wing mobile telephone, when the rotary wing of mobile telephone is opened; the mobile telephone body and the rotary wing form a certain angle, which is ergonomic.

To achieve the above objects, the present invention provides a rotary-wing type mobile telephone, comprising a mobile telephone body and a rotary wing; the rotary wing is pivotally connecting to the mobile telephone body by a rotating shaft, wherein the rotating shaft comprises:

A spindle provided at the center of the rotating shaft;

A fixing member hitched on the spindle and fixedly connected with the rotary wing of mobile telephone;

A rotating member pivotally provided on the spindle and fixedly connected with the mobile telephone body;

A limit mechanism provided between the fixing member and the rotating member, which limits the rotary wing in the range of rotating through 180 degrees clockwise or counterclockwise.

The rotary-wing type mobile telephone as above described, wherein, the rotary-wing type mobile telephone also includes a LCD screen provided on the outside or inside surface of the rotary wing.

The rotary-wing type mobile telephone as above described, wherein, the spindle of the rotating shaft is hollow, through which passes an electrical connecting cable or a flexible printed board provided between the rotary wing and the body.

The rotary-wing type mobile telephone as above described, wherein, the lower end of the rotary wing of mobile telephone is provided with a first handset, and the upper end is provided with a second handset, the two handsets being connected electrically with a sound signal output device of the mobile telephone body, and the rotary-wing type mobile telephone also has a sound signal switching device which is provided between the sound signal output device, the first handset and the second handset, and switches and outputs sound signals to the first handset or the second handset according to the state of the rotary wing.

The rotary-wing type mobile telephone as above described, wherein, the outer profile of the rotary wing is smaller than that of the body, and the body is formed with a projection outside the closed profile of the rotary wing, the projection being flush with the rotary wing in a closed state and provided thereon with a plurality of functional keys, which keys can be used to operate the mobile telephone when the rotary wing is closed.

The rotary-wing type mobile telephone as above described, wherein, there is a first acute angle formed between the rotating shaft and the horizontal datum plane of the mobile telephone, and an equal second acute angle respectively formed between the rotary wing and the rotating shaft and between the body and the rotating shaft, the first acute angle and the second acute angle being the complementary angles to each other, and the rotary wing which is rotated to open form an angle with the body based on the above-mentioned mounting structures.

The rotary-wing type mobile telephone as above described, wherein, the spindle of the rotating shaft is formed at both ends thereof with a first positioning portion and at mid-section thereof with a rotary portion; the fixing member is hitched on the first positioning portion of the spindle; the rotating member is pivotally provided on the rotary portion of the spindle; the limit mechanism comprises a limit block provided on the fixing member and a rotatable limit component pivotally provided on the rotary portion of the spindle and provided with a radially protruding first protruding block; the rotating member is coupled to the rotatable limit component and leaves some rotating space, when the rotary wing drives the rotating member rotating, it further drives the rotatable limit component rotating, and when the first protruding block provided on the rotatable limit component is blocked by the limit block provided on the fixing member, the rotary wing has rotated through 180 degrees.

The rotary-wing type mobile telephone as above described, wherein, the rotatable limit component is ring-shaped rotatable limit member, the rotating member is formed at an end surface thereof adjacent to the rotatable limit member with an axially extending ring-shaped protrusion which is provided with an opening, the first protruding block of the rotatable limit member is embedded in the opening whose width is larger than that of the first protruding block; when the rotating member rotates about the spindle, the ring-shaped protrusion comes into contact with the protruding block to drive the rotatable limit member rotating.

The rotary-wing type mobile telephone as above described, wherein, the rotatable limit component in turn comprises a first rotating member, a rotatable limit member and a second rotating member; the second rotating member is fixedly connected to the rotating member and formed at the interior circumference thereof with a plurality of first open slots; the first protruding block of the rotatable limit component is formed on the rotatable limit member which is formed at the interior circumference thereof with a plurality of second open slots in correspondence with the locations of the first open slots; the first rotating member is provided with a plurality of axially extending third protruding blocks which are inserted into the first open slots formed on the second rotating member through the second open slots formed on the rotatable limit member; the circumferential width of the second open slots is larger than that of the third protruding blocks; when the rotary wing drives the rotating member rotating, it further drives the first rotating member and the second rotating member rotating and simultaneously drives the rotatable limit member rotating.

The rotary-wing type mobile telephone as above described, wherein, the second rotating member is formed thereon with a plurality of second protruding blocks and the rotating member is correspondingly formed with a plurality of slots, the second protruding blocks are inserted into the slots, so that the second rotating member is fixedly connected to the rotating member.

The rotary-wing type mobile telephone as above described, wherein, the rotating shaft also comprises a locking member which is provided the side of the rotating member away from the fixing member and can lock the rotary wing of mobile telephone in a closed or opened position.

The rotary-wing type mobile telephone as above described, wherein, the locking member comprises a self-locked positioning member and two elastic slices covered each other, the spindle is provided with a second positioning portion, the self-locked positioning member and the two elastic slices are in turn provided at the side of the rotating member away from the fixing member and hitched on the second positioning portion of the spindle to be fixed to the spindle relatively; the self-locked positioning member is provided at the side opposite to the rotating member with two projections which are radially symmetrically arranged at 180 degrees, the corresponding side of the rotating member is provided with two grooves corresponding to the two projections.

The rotary-wing type mobile telephone as above described, wherein, the front shell of the mobile telephone body is provided with a sunken positioning groove corresponding to the rotating shaft; the depth of the positioning groove coincide with the height of the rotating shaft, and the rotating shaft is provided in the positioning groove and fixes the rotating member to the positioning groove, and the back shell of the rotary wing of mobile telephone is fixed to the fixing member of the rotating shaft.

The present invention also provides a controlling method of mobile telephone for controlling the operation of a mobile telephone provided on the mobile telephone body with a rotary wing, wherein comprises following steps:

a. Setting a step of opening the mobile telephone, to make the rotary wing of mobile telephone rotate about a rotating shaft at a certain angle, thus rotating the rotary wing away from a closed position relative to the mobile telephone body;

b. Setting a step of limiting and locking, to allow the rotary wing to rotate clockwise or counterclockwise in a range of 180 degrees, and be self-locked in an opening position when the rotary wing is close to 180°;

c. Setting a step of rotating the rotary wing back, to make the rotary wing rotate from the opening position back to closed position along the original path.

The controlling method of mobile telephone as above described, wherein, further comprises a step of controlling the displaying of the LCD screen provided on the rotary wing of mobile telephone.

The controlling method of mobile telephone as above described, wherein, the displaying signals of the LCD screen is transmitted from the mobile telephone body through a cable provided at the center of the rotating shaft to the LCD screen.

The controlling method of mobile telephone as above described, wherein, during setting the step of limiting and locking, the rotary wing form an angle with the body when the rotary wing is in the opening position.

The controlling method of mobile telephone as above described, wherein, further comprises a step of setting the displaying direction of LCD screen, to make the LCD screen provided on the rotary wing self flip over when the rotary wing is switched between the opening position and the closed position.

The controlling method of mobile telephone as above described, wherein, further comprises a step of setting the working state of switching the handsets, to make the working states of the first handset and the second handset provided on the rotary wing of mobile telephone be self-switched when the rotary wing is switched between the opening position and the closed position.

The beneficial effects of the present invention are that, since the rotary-wing type mobile telephone according to the present invention has a specifically designed rotating shaft, the rotating shaft having not only a conventional fixing member and a rotating member, but also a limit mechanism under which action the rotating member can rotate through 180 degrees only clockwise or counterclockwise, and thus transmission signal lines cannot be twisted seriously, and the rotary wing which is rotated to open can return only along the original path, so that the twisted signal lines can restore to the original state, thereby assuring the working life of the transmission signal lines.

Since the rotating shaft according to the present invention has a self-locked mechanism which is in a state of being self-locked while the mobile telephone is closed or rotated to be open completely, and is convenient for user to operate and provides a certain security, the self-locked mechanism will not be unlocked until a certain rotating force is applied to the rotary wing of mobile telephone, so as to prevent the mobile telephone from undesirably sliding out of the rotary wing.

Since the rotating shaft according to the present invention utilizes such a specific mounting way that the axis of the rotating shaft makes a certain angle with the horizontal datum plane of the mobile telephone, and the rotating shaft is completely provided in the sunken positioning groove of the mobile telephone body, the rotation surface of the rotary wing of mobile telephone is a taper-shaped curved surface, the rotary wing of mobile telephone in a opening state and the mobile telephone body form a certain angle, which is ergonomic.

Now, the present invention will be further described with reference to the accompanying drawings and specific embodiments.

### DESCRIPTION OF THE DRAWING

FIG. 1 is a view for illustrating a rotary-wing type mobile telephone in a state of using according to the prior art;

FIG. 2 is a view for illustrating a rotary-wing type mobile telephone according to the prior art, with a rotary wing in an opening position;

FIG. 3 is a schematic diagram for illustrating a rotary-wing type mobile telephone placed perpendicularly according to the present invention;

FIG. 4 is a schematic diagram for illustrating a rotary-wing type mobile telephone placed horizontally according to the present invention;

FIG. 5A is a schematic diagram for illustrating a rotary-wing type mobile telephone opening counterclockwise according to the present invention;

FIG. 5B is a schematic diagram for illustrating a rotary-wing type mobile telephone opening clockwise according to the present invention;

FIG. 5C is a side view for illustrating a rotary-wing type mobile telephone in a state of opening according to the present invention;

FIG. 6A is an assembly constitutional diagram of a rotating shaft of a rotary-wing type mobile telephone according to a first embodiment of the present invention;

FIG. 6B is a schematic diagram for illustrating the center of the rotating shaft of the rotary-wing type mobile telephone passing through a communication cable according to the present invention;

FIGS. 7A, 7B and 7C are schematic diagrams for illustrating the rotating shaft during being operated according to the first embodiment of the present invention;

FIG. 8 is an exploded constitutional diagram for illustrating a rotating shaft of a rotary-wing type mobile telephone according to a second embodiment of the present invention;

FIG. 9A is a schematic diagram for illustrating the rotating shaft of the rotary-wing type mobile telephone in a locked position according to the present invention;

FIG. 9B is a schematic diagram for illustrating the rotating shaft of the rotary-wing type mobile telephone in an unlocked position according to the present invention;

FIG. 10A is an entirety schematic diagram for illustrating the rotating shaft of the rotary-wing type mobile telephone during being mounted according to the present invention;

FIGS. 10B and 10C are schematic diagrams for illustrating the mounting steps of the rotating shaft of the rotary-wing type mobile telephone according to the present invention.

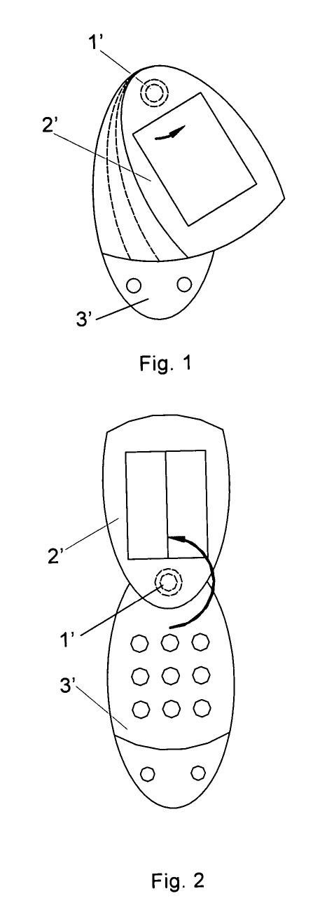

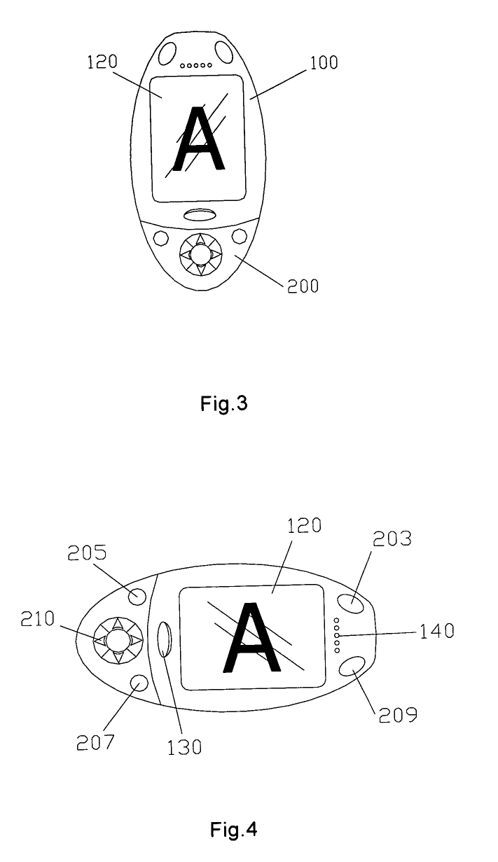

### BEST MODE FOR CARRYING OUT THE INVENTION

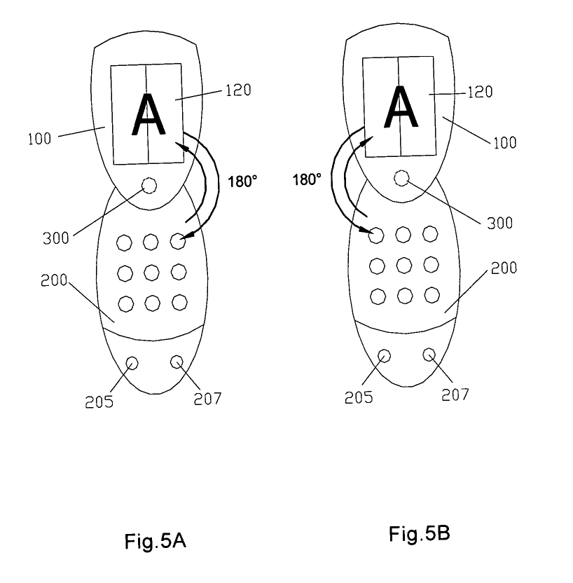

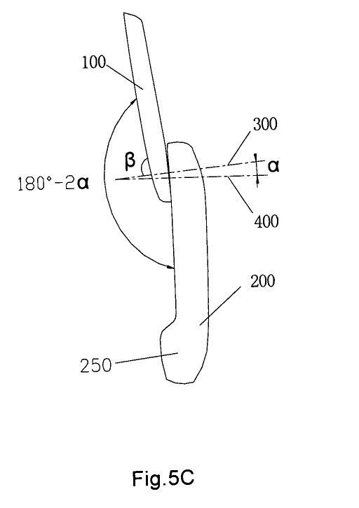

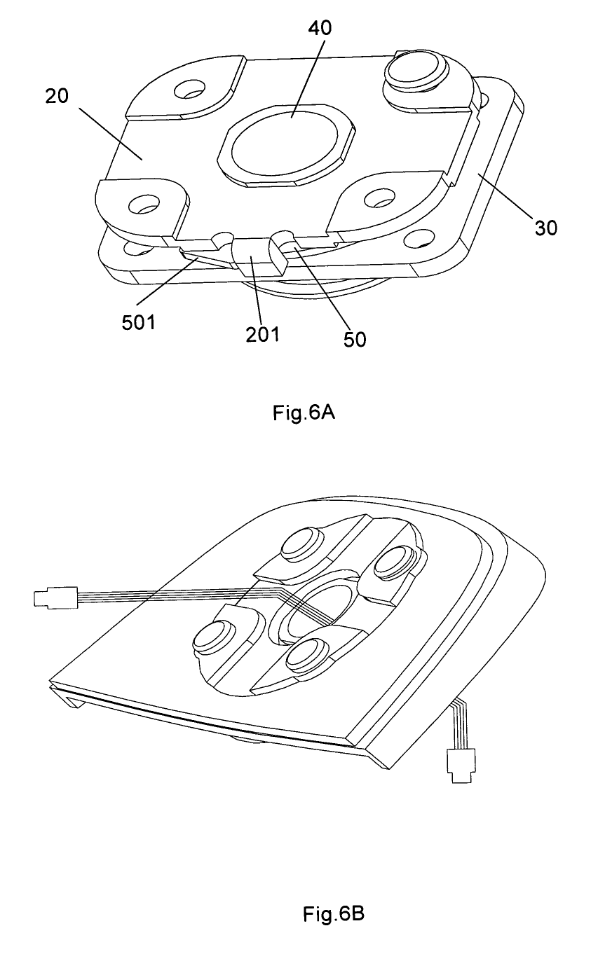

FIG. 3 and FIG. 4 are schematic diagrams for illustrating a rotary-wing type mobile telephone according to the present invention. The rotary-wing type mobile telephone according to the present invention comprises a rotary wing 100 and a body 200, and a LCD screen 120 is provided on the rotary wing 100, as shown in FIG. 5A and FIG. 5B, the rotary wing 100 is pivotally provided on the mobile telephone body 200 by a rotating shaft 300. In order to increase the working life of mobile telephone and prevent a communication connecting cable between the rotary wing and the body from being twisted off, the rotary wing according to the present invention is designed to rotate through 180 degrees only clockwise or counterclockwise, and can return only along the original path. This is realized by the specific design of rotating shaft 300.

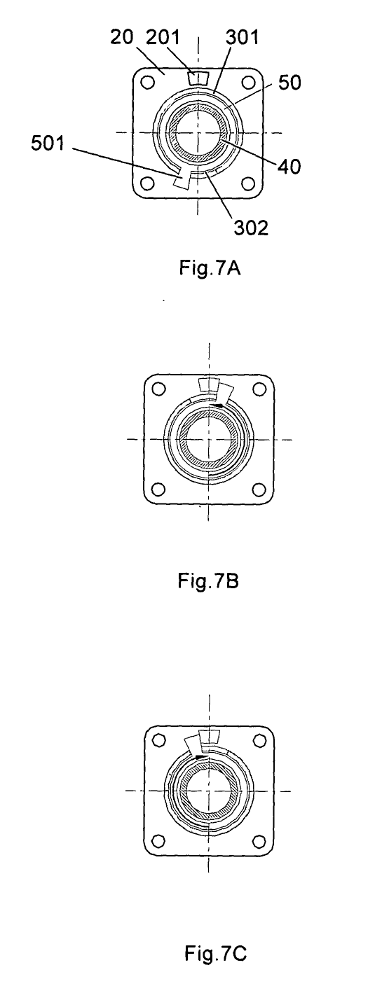

As shown in FIG. 6A, it is a constructional drawing for illustrating a rotating shaft of rotary-wing type mobile telephone according to a first embodiment of the present invention. The rotating shaft 300 includes a fixing member 20, a rotating member 30 and a hollow spindle 40 thereof. The fixing member 20 and the spindle 40 is relatively fixedly connected together, this can be such achieved that one end of the spindle 40 is designed to be a polygonal positioning portion, and the center of the fixing member 20 is also designed to be a positioning portion for corresponding polygonal hole, then they are locked each other to realize the fixing connection of relative position. The rotating member 30 is pivotally connected to the spindle 40 and rotatable about the spindle 40. The fixing member 20 and the rotating member 30 are both provided with mounting surface and may be via screws connected with the body and the rotary wing of a mobile telephone.

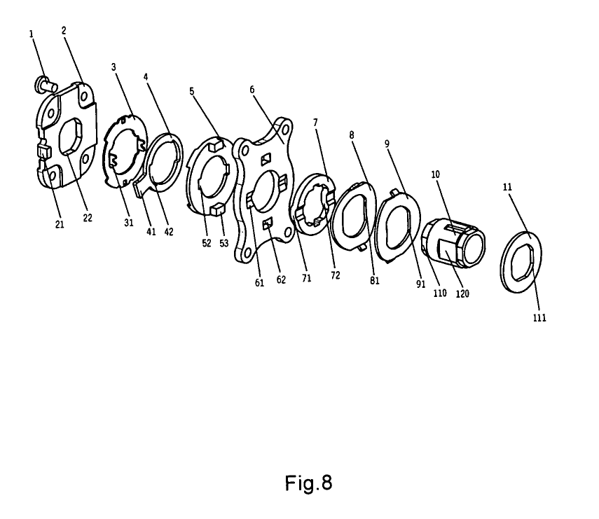

Simultaneously referring to FIG. 7A, in order to limit the rotating member 30 after rotating through 180 degrees, according to the present embodiment, the rotating shaft of the present embodiment further includes a limit mechanism comprising a limit block 201 which is protrusively provided on the other side of the mounting surface of the fixing member 20, and a rotatable limit member 50 which can cause the rotating member 30 to be blocked by the limit block 201 after rotating through 180 degrees clockwise and counterclockwise, the rotatable limit member is also pivotally provided on the spindle 40 and rotatable about the spindle 40 in response to the rotating member 30. The rotatable limit member 50 is provided at the circumferential outside thereof with a first protruding block 501, and a ring-shaped protrusion 301 extends outwards from the inside of the rotating member 30, which is formed with an opening 302 having a specified width larger than that of the first protruding block 501. The first protruding block 501 of the rotatable limit member 50 is embedded into the opening 302 and leaves some space, when the rotating member 30 rotates about the spindle 40, the protrusion 301 drives the rotatable limit member 50 rotating together via the opening 302.

As shown in FIG. 4B, when the rotating member 30 rotates counterclockwise with the rotatable limit member 50 being rotated together, if the first protruding block 501 of the rotatable limit member 50 is blocked by the limit block 201 formed on the fixing member 20, the rotating member 30 just rotates 180 degrees, at this time, the rotating member 30 can return only along the original path clockwise. As shown in FIG. 4A, because the width of the opening 302 is larger than that of the first protruding block 501, when the rotating member 30 rotates clockwise, the rotating member 30 does not drive the rotatable limit member 50 at once, but rotates itself firstly, and does not start to drive the rotatable limit member 50 rotating until it rotates to one side of the opening 32 to contact the first protruding block 501, as shown in FIG. 4C. When they are rotated together till the protruding block 501 is blocked by the limit block 201, the rotating member 30 has exactly rotated through 180 degrees, at this time, the rotating member 30 remain returns along the original path. It is known from the above description, the construction of the rotating shaft of the present invention allow the rotating member 30 to rotate through 180 degrees clockwise or counterclockwise and also return merely along the original path, to prevent the cable or the flexible printing plate (as shown in FIG. 6B) in the rotating shaft from being overly twisted. In this embodiment, since the limit block 201 and the first protruding block 501 both have a certain width, the width of the opening 302 formed on the rotating member 30 must be larger than that of the first protruding block 501, and the practical value is determined in accordance with the width of the limit block 201 and the first protruding block 501. Thus, it can cause the rotating member 30 and the limit member 50 to be rotated oppositely, and finally ensure that the rotating member 30 would not be blocked by the limit block 201 until it has rotated 180 degrees when rotates clockwise and counterclockwise.

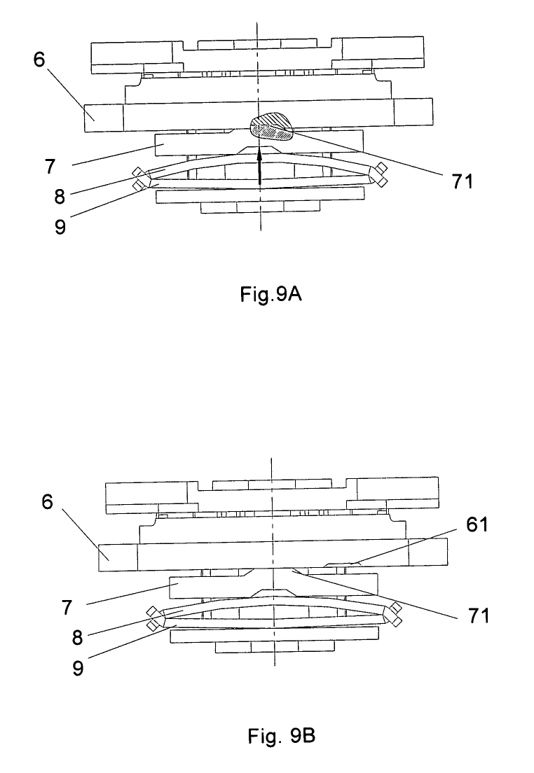

As shown in FIG. 8, it is an exploded constitutional diagram for illustrating a rotating shaft of rotary-wing type according to a second embodiment of the present invention. Compared to the first embodiment, the second embodiment also includes a rotating member 6 pivotally provided on the spindle 10, a hollow spindle 10, which is formed at both ends thereof with polygonal positioning portions 110, and a fixing member 2 formed with a corresponding polygonal positioning hole 22 and a limit block 21 and fixed to one end of the spindle 10 by the positioning hole 22 so as to be fixed relative to the spindle, The rotatable limit component of the limit mechanism of the second embodiment consists of three structural members, respectively, a first rotating member 3, a rotatable limit member 4 and a second rotating member 5, which are in turn hitched on the spindle 10 and can rotate about the spindle; where an end surface of the second rotating member 5 is formed at the external circumference thereof with a plurality of axially extending second protruding blocks 53, the corresponding position of the rotating member 6 is provided with a plurality of slots 62, the second protruding blocks 53 formed on the second rotating member 5 are inserted into the slots 62 provided on the rotating member 6 so as to cause the second rotating member 5 to rotate in response to the rotation of the rotating member 6; the rotatable limit member 4 is radially formed with a first protruding block 41 and formed at the interior circumference thereof with a plurality of second open slots 42; the first rotating member 3 is formed at the interior circumference thereof with a plurality of axially extending third protruding blocks 31, the projections 31 are respectively inserted into a plurality of a first open slots 52 formed on the interior circumference of the second rotating member 5 through a plurality of the second open slots 42 on the limit member 4; thus, the first rotating member 3 and the rotatable limit member 4 can also be rotated about the spindle 10 in response to the rotation of the second rotating member 5.

Similar to the first embodiment, since the second protruding blocks 53 are tightly inserted into the slots 62 of the rotating member 6, when the rotating member 6 rotates, it drives the second rotating member 5 rotating at once, at the same time, since the third protruding blocks 31 are tightly inserted into the first open slots 52, the rotating member 3 is therefore also driven to rotate. For the same reason as the first embodiment, the arc width of the second open slots 42 should be larger than that of the third protruding block 31, so that the first rotating member 3 and the second rotating member 5 take a idle travel first, the rotatable limit member 4 is then driven to rotate. When the first protruding block 41 formed on the rotatable limit member 4 comes into contact with the limit block 21 formed on the fixing member 2, the rotating member 6 rotates 180 degrees relative to the fixing member 2, then return merely along the original path. Apparent from the drawing, in the second embodiment, it also allow the rotating member 6 to rotate through 180 degrees clockwise or counterclockwise and return along the original path. Naturally, in order to cause the rotating angle to be accurately controlled within 180 degrees when rotated clockwise and counterclockwise so as to be limited, the circumference width of the second open slot 42 should be correspond with that of the limit block 21, that of the first protruding block 41 and that of the third protruding block 31.

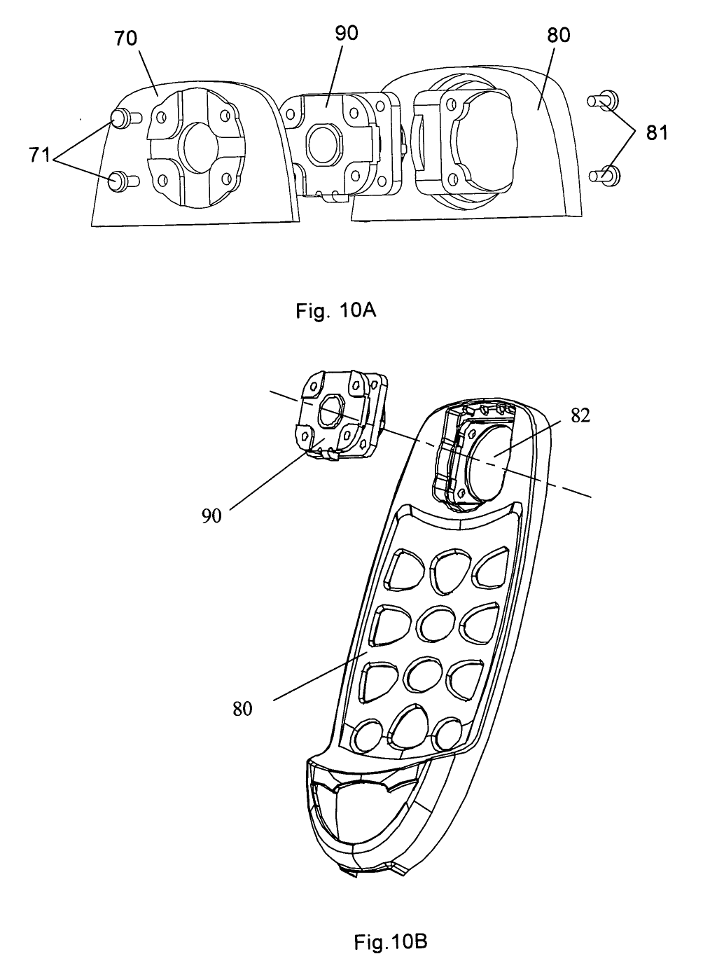

As shown in FIG. 9A, in order to be locked after having rotated 180 degrees, the second embodiment of the present invention is provided with a self-locked mechanism which comprises a self-locked positioning member 7 and two elastic slices 8, 9 covered each other, they are in turn hitched on the spindle 10 on which the matching surfaces are a plurality of planes 120, the interior circumferences of the self-locked positioning member 7 and the two elastic slices 8, 9 are respectively formed with corresponding straight segments 72,81,91 which are matched with the planes 120 formed on the spindle so that the self-locked mechanism is fixed to the spindle relatively.

The self-locked positioning member 7 is formed at its one end surface facing towards the rotating member 6 with two axial protrusions 71 which are radially symmetrically arranged at 180 degrees, and the rotating member 6 is formed with two corresponding grooves 61; As shown in FIG. 9A, the shapes of the grooves 61 are matched with that of the protrusions 71, as the rotary wing connected to the rotating member 6 is closed relative to the body, the two protrusions 71 are rightly provided inside the two grooves 61 of the rotating member 6, respectively. Because the elastic slices 8,9 apply a certain pre-pressure when mounted, the elastic slices then apply a certain pressure to the matching construction all the times, so in the case of no external force, the protrusions 71 may not slide out of the grooves 61 so as to be self-locked; As illustrated in FIG. 9B, only if the rotating member 6 is rotated with a certain pressure, the protrusions 71 could slide out of the grooves 61 to cause the rotating member 6 to start to rotate. After the rotating member 6 has rotated 180 degrees, due to the symmetry, the two protrusions 71 herein slide into the grooves 61 so as to be similarly self-locked.

As shown in FIG. 8, in order to mount the rotating shaft conveniently, the other end of the rotating shaft is also mounted with a cap 11 inside which positioning polygon 111 is firmly matched with the polygonal positioning portion 110 of the spindle.

In the rotary-wing type mobile telephone of the present invention, the mobile telephone body is pivotally connected with the rotary wing together by the rotating shaft. Actually, in the present invention, the rotating member 6 of the rotating shaft is positioned relative to the fixing member 2, while the rotating member 6 is fixed, the fixing member 2 rotates, thus it can be seen that the method of mounting the rotating shaft can be flexibly changed according to practical situations.

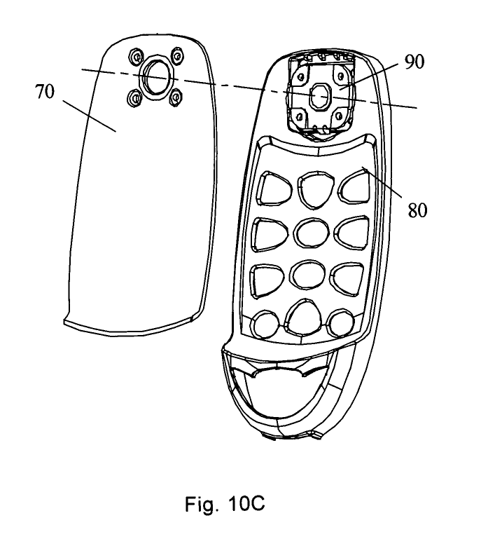

FIGS. 10A, 10B and 10C are constructional schematic diagrams for illustrating the rotating shaft 90 mounted between the rotary wing 70 and the body 80 of the mobile telephone. As can be seen from the drawings, an upper end of a front shell 80 of the body is formed with a sunken positioning groove 82 whose depth coincides with the height of the rotating shaft, thus approximately flush with the front shell 80 after the rotating shaft 90 being provided in the positioning groove 82, and the rotating member of the rotating shaft 90 is mounted on the mobile telephone 80 by a set of screws 81, and the fixing member of the rotating shaft 90 is mounted on the rotary wing by another set of screws 81.

As shown in FIG. 4, in order for user to receive the telephone conveniently in a state of the rotary wing being opened and closed, in the rotary-wing type mobile telephone according to the present invention, the lower end of the rotary wing is provided with a first handset 130, and the upper end is provided with a second handset 140, two handsets being connected electrically with a sound signal output device (not shown), and in order to switch sound signals between two handsets, the rotary-wing type mobile telephone also has a sound signal switching device (not shown) which is provided between the sound signal output device and the first handset, the second handset, and switches and outputs sound signals to the first handset or the second handset according to the state of the rotary wing, the sound signal switching device may consist of a Hall element and a analog switch.

As shown in FIG. 4 and FIG. 5C, in the rotary-wing type mobile telephone according to the present invention, the outer profile of the rotary wing 100 is smaller than that of the body 200, and the body 200 is formed at the lower part thereof with a projection 250 being just flush with the rotary wing 100 when closed, thus making the mobile telephone form into a streamlined unity. There are a plurality of keys 205, 207 and 210 provided on the projection 250, and a plurality of keys 203 and 209 are also provided on the rotary wing, which keys can be used to operate the mobile telephone when the rotary wing is closed.

As shown in FIG. 5C, in order to cause the rotary wing of the mobile telephone to be arranged at an angle rather than parallel to the mobile telephone body after being rotated to open, and also in order to be convenient for user, in the rotary-wing type telephone according to the present invention, it allows the rotating shaft 90 to be mounted at a slant angle, that is, there is a angle α between the mounting axis 100 of the rotating shaft 90 and the horizontal datum plane of the mobile telephone, and an angle β formed between the rotary wing and the rotating shaft 90 is adjusted to be a complementary angle to the slant angle of the rotating shaft, so that there will be a mounting angle (180°-2α) between the rotary wing and the mobile telephone body after the rotary wing rotates to open, thus making the mobile telephone ergonomic.

As shown in FIG. 3 and FIG. 4, when an incoming telephone is received, one can use the keys 205 and 207 to directly listen to it, without the need of opening the rotary wing 100, thus making the operation convenient. As shown in FIG. 4, when the mobile telephone is placed laterally, the LCD screen 120 of the mobile telephone can be self flipped over to be convenient for user to see, at this time, user can use the exposed keys 203, 205, 207, 209 and direction key 210 to play the game.

The rotary wing 100 will be firstly opened when one tends to use a keyboard. At this time, a rotating external force should be applied on the rotary wing 100, to disengage it from the locked position and rotate through 180 degrees clockwise or counterclockwise to the opening position, and the mobile telephone can be self-locked at the locked position approximately between 170° and 180°, and the screen 120 will be self flipped over during rotating, so that it remains to face to user after being opened. At this time, user can carry out a series of functional operations of general mobile telephone such as short message sending operation, network communicating operation, and setting modifying operation or the like. When the operations are finished to close the rotary wing, an external force still needs to be applied on the rotary wing to separate the mobile telephone from the self-locked position and return to the closed position along the original path, and then be self-locked.

Thus, since the rotary wing has a self-locked function at 0° and 180°, a certain external force is needed to be applied to rotate it, so that when the mobile telephone according to the present invention is either stood by or operated, the rotating portion would not be swing at random to be convenient for user.

In addition, during the rotation of the rotary wing of mobile telephone, the first handset and the second handset on the rotary wing also carry out the switching of working state automatically to be convenient for user to receive the phone call.

Overall, the rotary-wing type mobile telephone according to the present invention has following advantages:

1. Since the rotary-wing type mobile telephone according to the present invention has a specifically designed rotating shaft, the rotating shaft having not only a conventional fixing member and a rotating member, but also a limit mechanism under which action the rotating member can rotate through 180 degrees only clockwise or counterclockwise, and thus transmission signal lines cannot be twisted seriously, and the rotary wing which is rotated to open can return only along the original path, so that the twisted signal lines can restore to the original state, thereby assuring the working life of the transmission signal lines.

2. Since the rotating shaft according to the present invention has a self-locked mechanism which is in a state of being self-locked while the mobile telephone is closed or rotated to be open completely, and is convenient for user to operate and provides a certain security, the self-locked mechanism will not be unlocked until a certain rotating force is applied to the rotary wing of mobile telephone, so as to prevent the mobile telephone from undesirably sliding out of the rotary wing.

3. Since the rotating shaft according to the present invention utilizes such a specific mounting way that the axis of the rotating shaft makes a certain angle with the horizontal datum plane of the mobile telephone, and the rotating shaft is completely provided in the sunken positioning groove of the mobile telephone body, the rotation surface of the rotary wing of mobile telephone is a taper-shaped curved surface, the rotary wing of mobile telephone in a opening state and the mobile telephone body form a certain angle, which is ergonomic.

4. The LCD screen is provided on the rotary wing of mobile telephone, which is fashionable and beautiful and is in favor of the miniaturization of mobile telephone.

5. The mobile telephone according to the present invention is provided with a construction of two handsets, the two handsets can be self-switched to be convenient for user to receive the phone call.

6. During the rotating of the rotary wing, the working state of the two handsets and displaying direction of the LCD screen can be self switched, without the need of man-made operation, thus taking account of individuation and humanization at the same time.

While a few preferred embodiments of the present invention have been shown and described above, and it is not confined to the embodiments of the present invention, it will be obvious to those skilled in the art that equivalent constructional changes may be made according to the description and the accompanying drawings, without departing from the scope of the present invention.

What is claimed is:

1. A rotary-wing type mobile telephone, comprising a mobile telephone body and a rotary wing, the rotary wing is pivotally connecting to the mobile telephone body by a rotating shaft, wherein the rotating shaft comprises:
A spindle provided at the center of the rotating shaft;
A fixing member hitched on the spindle and fixedly connected with the rotary wing of mobile telephone;
A rotating member pivotally provided on the spindle and fixedly connected with the mobile telephone body;
A limit mechanism provided between the fixing member and the rotating member, which limits the rotary wing in the range of rotating through 180 degrees clockwise or counterclockwise.

2. The rotary-wing type mobile telephone as claimed in claim 1, wherein the rotary-wing type mobile telephone also includes a LCD screen provided on the outside or inside surface of the rotary wing.

3. The rotary-wing type mobile telephone as claimed in claim 1, wherein the spindle of the rotating shaft is hollow, through which passes an electrical connecting cable or a flexible printed board provided between the rotary wing and the body.

4. The rotary-wing type mobile telephone as claimed in claim 1, wherein the lower end of the rotary wing of mobile telephone is provided with a first handset, and the upper end is provided with a second handset, the two handsets being connected electrically with a sound signal output device of the mobile telephone body, and the rotary-wing type mobile telephone also has a sound signal switching device which is provided between the sound signal output device, the first handset and the second handset, and switches the outputs sound signals to the first handset or the second handset according to the state of the rotary wing.

5. The rotary-wing type mobile telephone as claimed in claim 1, wherein the outer profile of the rotary wing is smaller than that of the body, and the body is formed with a projection outside the closed profile of the rotary wing, the projection being flush with the rotary wing in a closed state and provided thereon with a plurality of functional keys, which keys can be used to operate the mobile telephone when the rotary wing is closed.

6. The rotary-wing type mobile telephone as claimed in claim 5, wherein there is a first acute angle formed between the rotating shaft and the horizontal datum plane of the mobile telephone, and an equal second acute angle respectively formed between the rotary wing and the rotating shaft and between the body and the rotating shaft, the first acute angle and the second acute angle being the complementary angles to each other, and the rotary wing which is rotated to open form an angle with the body based on the above-mentioned mounting structures.

7. The rotary-wing type mobile telephone as claimed in claim 2, 3, 4, 5 or 6, wherein the spindle of the rotating shaft is formed at both ends thereof with a first positioning portion and at mid-section thereof with a rotary portion; the fixing member is hitched on the first positioning portion of the spindle; the rotating member is pivotally provided on the rotary portion of the spindle; the limit mechanism comprises a limit block provided on the fixing member and a rotatable limit component pivotally provided on the rotary portion of the spindle and provided with a radially protruding first protruding block; the rotating member is coupled to the rotatable limit component and leaves some rotating space, when the rotary wing drives the rotating member rotating, it further drives the rotatable limit component rotating, and when the first protruding block provided on the rotatable limit component is blocked by the limit block provided on the fixing member, the rotary wing has rotated through 180 degrees.

8. The rotary-wing type mobile telephone as claimed in claim 7, wherein the rotatable limit component is ring-shaped rotatable limit member, the rotating member is formed at an end surface thereof adjacent to the rotatable limit member with an axially extending ring-shaped protrusion which is provided with an opening, the first protruding block of the rotatable limit member is embedded in the opening whose width is larger than that of the first protruding block; when the rotating member rotates about the spindle, the ring-shaped protrusion comes into contact with the protruding block to drive the rotatable limit member rotating.

9. The rotary-wing type mobile telephone as claimed in claim 7, wherein the rotatable limit component in turn comprises a first rotating member, a rotatable limit member and a second rotating member; the second rotating member is fixedly connected to the rotating member and formed at the interior circumference thereof with a plurality of first open slots; the first protruding block of the rotatable limit component is formed on the rotatable limit member which is formed at the interior circumference thereof with a plurality of second open slots in correspondence with the locations of the first open slots; the first rotating member is provided with a plurality of axially extending third protruding blocks which are inserted into the first open slots formed on the second rotating member through the second open slots formed on the rotatable limit member; the circumferential width of the second open slots is larger than that of the third protruding blocks; when the rotary wing drives the rotating member rotating, it further drives the first rotating member and the second rotating member rotating and simultaneously drives the rotatable limit member rotating.

10. The rotary-wing type mobile telephone as claimed in claim 9, wherein the second rotating member is formed thereon with a plurality of second protruding blocks and the rotating member is correspondingly formed with a plurality of slots, the second protruding blocks are inserted into the slots, so that the second rotating member is fixedly connected to the rotating member.

11. The rotary-wing type mobile telephone as claimed in claim 1, 2, 3, 4, 5 or 6, wherein the rotating shaft also comprises a locking member which is provided the side of the rotating member away from the fixing member and can lock the rotary wing of mobile telephone in a closed or opened position.

12. The rotary-wing type mobile telephone as claimed in claim 11, wherein the locking member comprises a self-locked positioning member and two elastic slices covered each other, the spindle is provided with a second positioning portion, the self-locked positioning member and the two elastic slices are in turn provided at the side of the rotating member away from the fixing member and hitched on the second positioning portion of the spindle to be fixed to the spindle relatively; the self-locked positioning member is provided at the side opposite to the rotating member with two projections which are radially symmetrically arranged at 180 degrees, the corresponding side of the rotating member is provided with two grooves corresponding to the two projections.

13. The rotary-wing type mobile telephone as claimed in claim 1, wherein the front shell of the mobile telephone body is provided with a sunken positioning groove corresponding to the rotating shaft, the depth of the positioning groove being coinciding with the height of the rotating shaft, and the rotating shaft is provided in the positioning groove and fixes the rotating member to the positioning groove, and the back shell of the rotary wing of mobile telephone is fixed to the fixing member of the rotating shaft.

14. A controlling method of mobile telephone for controlling the operation of a mobile telephone provided on the mobile telephone body with a rotary wing, wherein comprises following steps:
a. Setting a step of opening the mobile telephone, to make the rotary wing of mobile telephone rotate about a rotating shaft at a certain angle, thus rotating the rotary wing away from a closed position relative to the mobile telephone body;
b. Setting a step of limiting and locking, to allow the rotary wing to rotate clockwise or counterclockwise in a range of 180 degrees, and be self-locked in an opening position when the rotary wing is close to 180°;
c. Setting a step of rotating the rotary wing back, to make the rotary wing rotate from the opening position back to closed position along the original path.

15. The controlling method of mobile telephone as claimed in 14, wherein further comprises a step of controlling the displaying of the LCD screen provided on the rotary wing of mobile telephone.

16. The controlling method of mobile telephone as claimed in 15, wherein the displaying signals of the LCD screen is transmitted from the mobile telephone body through a cable provided at the center of the rotating shaft to the LCD screen.

17. The controlling method of mobile telephone as claimed in 14, wherein setting the step of limiting and locking, the rotary wing form an angle with the body when the rotary wing is in the opening position.

18. The controlling method of mobile telephone as claimed in 14, wherein further comprises a step of setting the displaying direction of LCD screen, to make the LCD screen provided on the rotary wing self flip over when the rotary wing is switched between the opening position and the closed position.

19. The controlling method of mobile telephone as claimed in 14, wherein further comprises a step of switching the working state of the handsets, to make the working states of the first handset and the second handset provided on the rotary wing of mobile telephone be self-switched when the rotary wing is switched between the opening position and the closed position.
